(19) United States
(12) Patent Application Publication
(10) Pub. No.: US 2022/0151273 A1
(43) Pub. Date: May 19, 2022

(54) Process for Preparing a Customizable Seasoning Composition, Customized Seasoning Compositions, and Related Systems and Kits

(71) Applicant: FoodStudio LLC, Philadelphia, PA (US)

(72) Inventors: Atsuko Anne Boyd, Philadelphia, PA (US); Christopher Jason Allen, Philadelphia, PA (US); Natalie Jeanne Goddard-O'Mara, Havertown, PA (US); David Leon Navarro, Philadelphia, PA (US)

(21) Appl. No.: 17/592,031

(22) Filed: Feb. 3, 2022

Related U.S. Application Data
(63) Continuation of application No. 17/591,761, filed on Feb. 3, 2022.
Application No. 17/591,761 is a continuation of application No. 16/007,751, filed on Jun. 13, 2018, now abandoned.
(60) Provisional application No. 62/518,906, filed on Jun. 13, 2017.

(51) Int. Cl. A23L 27/40; A23L 27/00; A23L 27/10; A23L 27/12

(52) U.S. Cl. CPC A23L 27/40; A23L 27/88; A23V 2002/00; A23L 27/12; A23L 27/10

(57) ABSTRACT

The invention includes a customized process to prepare a seasoning composition to modify a gustatory sensation experienced by an individual when a food substrate and a grape-based alcoholic beverage are consumed and the seasoning composition prepared thereby. The process includes obtaining an amount of an edible salt; selecting a grape varietal from which the grape-based alcoholic beverage is derived; determining the pairing profile of the grape-based alcoholic beverage selected from Sweet, Dry and Acidic; selecting a gustatory objective from the group consisting of a balance objective, a contrast objective, and an enhancement objective. When the objective is balance and the pairing profile is Sweet, a salty component is added to the amount of salt to form a customized seasoning composition. When the objective is balance and the pairing profile is Dry, a component selected from a salty component and an umami component is added to the amount of salt to form a customized seasoning composition.

### CROSS-REFERENCE TO RELATED APPLICATIONS

This application claims the benefit under 35 U.S.C. § 119(e) of U.S. Provisional Patent Application No. 62/518,906, filed Jun. 13, 2017, the entire disclosure of which is incorporated herein by reference.

### BACKGROUND OF THE INVENTION

Wine drinkers of all levels of sophistication struggle with the problem of matching an appropriate wine to a food to achieve an enhanced dining experience. In an effort to find guidance, many rely on the tired platitude “White for chicken; Red for beef”. Such rules may have operated well in the 1960s-1970s era when the types of wine imported to the US were limited and the home cook was guided by Betty Crocker.

However, in the current US culinary climate which favors diverse and ethic flavors and/or wine imported from throughout the world, relying too much on this rule for guidance is fraught with drawbacks and uncertainties; Are non-beef eaters denied red wine altogether? How to apply the rule when the food is a robust flavored chicken, such as an Indian or Asian chicken dish? What about red-colored wines that have light flavors, like many of the Beaujolais or other wines traditionally consumed as vins de primeur?—and so on. A thicket of dilemmas face the home cook when attempting to match food and wine, making the task daunting.

For those oenophiles who struggle with wine/food matching, yet do not have the time or interest to engage in a sommelier-level study of wine and food, there remain few options. Thus, there remains a need in the art for kits, systems, or other devices that permit home cooks to skip the quandary associated with wine selection and simply match food and wine for an enhanced flavor experience of both the food and the wine as they are consumed together.

### BRIEF DESCRIPTION OF THE SEVERAL VIEWS OF THE DRAWINGS

The foregoing summary, as well as the following detailed description of preferred embodiments of the invention, may be better understood when read in conjunction with the appended drawings. For the purpose of illustrating the invention there are shown in the drawing embodiments which are presently preferred. It should be understood, however, that the invention is not limited to the precise arrangements and instrumentalities shown. In the drawings:

FIG. 1 is a chart showing an exemplary matrix of the Pairing Profiles with Corresponding flavor options combinable to achieve a gustatory objective; and

FIG. 2 is a flowchart illustrating an embodiment of the inventive method.

### BRIEF SUMMARY OF THE INVENTION

The invention includes a customized process to prepare a seasoning composition to modify a gustatory sensation experienced by an individual when a food substrate and a grape-based alcoholic beverage are consumed and the seasoning composition prepared thereby. The process includes obtaining an amount of an edible salt; selecting a grape varietal from which the grape-based alcoholic beverage is derived; determining the pairing profile of the grape-based alcoholic beverage selected from Sweet, Dry and Acidic; selecting a gustatory objective from the group consisting of a balance objective, a contrast objective, and an enhancement objective. When the objective is balance and the pairing profile is Sweet, a salty component is added to the amount of salt to form a customized seasoning composition. When the objective is balance and the pairing profile is Dry, a component selected from a salty component and an umami component is added to the amount of salt to form a customized seasoning composition.

When the objective is balance and the pairing profile is Acidic, a component selected from a salty component and an umami component is added to the amount of salt to form a customized seasoning composition. When objective is contrast, and the pairing profile is Sweet, a sweet component is added to the amount of salt to form a customized seasoning composition. When the objective is contrast and the pairing profile is Dry, a sweet component or a bitter component is added to the amount of salt to form to form a customized seasoning composition. When the objective is contrast and the pairing profile is Acidic, a sweet component is added to the amount of salt to form to form a customized seasoning composition. When the objective is enhance, and the pairing profile is Sweet, an acidic or a sweet component is added to the amount of salt to form to form a customized seasoning composition. When the gustatory objective is enhance, and the pairing profile is Dry, a sweet component is added to the amount of salt to form a customized seasoning composition. When the objective is enhance, and the pairing profile is Acidic, a component selected from acidic and sweet is added to the amount of salt to form a customized seasoning composition. Upon co-consumption by a diner of the grape-derived beverage and a food substrate to which the customized seasoning composition is applied, a gustatory sensation experienced by the individual differs from a gustatory sensation experienced by the diner upon co-consumption of the grape-derived beverage and the food substrate.

### DETAILED DESCRIPTION OF THE INVENTION

The invention as contemplated incudes methods of preparing a customized seasoning composition that can be used on any food substrate(s) when cooking. The customized substrate alters or modifies the perceived taste of the food by a consumer when the treated food is consumed contemporaneously with a grape-based beverage, such as a grape based alcoholic beverage, like wine. Also included within the scope of the invention are the customized seasoning compositions prepared by the method, related systems, and kits to allow a cook or chef to execute the methods in his or her own kitchen. Use of the customized seasoning composition allows the home cook to match virtually any food with any wine and still create an enhanced flavor experience of both the food and the wine with little or no knowledge of the culinary or oenological protocols conventionally employed to pair flavors.

The customized composition described herein is a salt-based composition. Salts that are suitable include any edible or “table salt”, usually made up primarily of sodium and/or magnesium chloride. The salt selected may be neat or may contain various small amounts of other ingredients present by virtue of the salts' origin or the commercial refining process to which it has been subjected. For example, fleur de sel/flor de sal, a type of sodium chloride sea salt may contain small amounts of magnesium, calcium halides, sulfates and traces of algal products; alaea salt, a sodium chloride sea salt obtained from certain Polynesian seasides contains small amounts of iron oxide, etc. Processed or refined salts may include small amounts of potassium iodide and/or anticaking agents like sodium aluminosilicate and magnesium carbonate.

Any form or particle size (“grain size”) of salt may be used. Option may include kosher salt, rock salt, flake salt, pearl salt, pickling salt, or combinations of the same. It may be preferred that the average particle size of the selected salt is about 100 to about 100 micrometers, about 200 to about 300 micrometers or larger.

In some embodiments, it may be preferred that the salt is an unprocessed and/or un-iodized kosher salt.

In practice of the method described herein, a salt or combination of edible salts is selected and an amount of that salt obtained. In an embodiment, the edible salt will make up about 10%, about 20%, about 30/s, about 35%, about 37%, about 40%, about 45%, about 50%, about 60%, about 70%, or about 80% of the final customized composition, by volume of the composition.

The method includes selecting a subtype of alcoholic beverage, such as wine, beer, spirit, liquor or aperitif, such as a grape or other vegetable varietal or spirits or liquor “taste”. Examples of beverages may include, without limitation, absinthe, brandy, sake, whiskey, tequila, scotch, rum, beer, lager or stout, vermouth, vodka, gin, bourbon, port and/or rye.

For examples, the method includes selecting a varietal of a grape-based beverage. The “varietal” as used herein is determined by the majority grape variety present (by volume) in the grape-based beverage. Any variety known or developed may be selected, including for example, Cabernet Sauvignon, Chardonnay, Merlot, Auxerrois, Negretté, Gamay, Riesling, Shiraz, Malbec, Pinot noir, Aligoté, Romorantin, Grenache, Muscadelle, Agiorgitiko, Godello, etc.

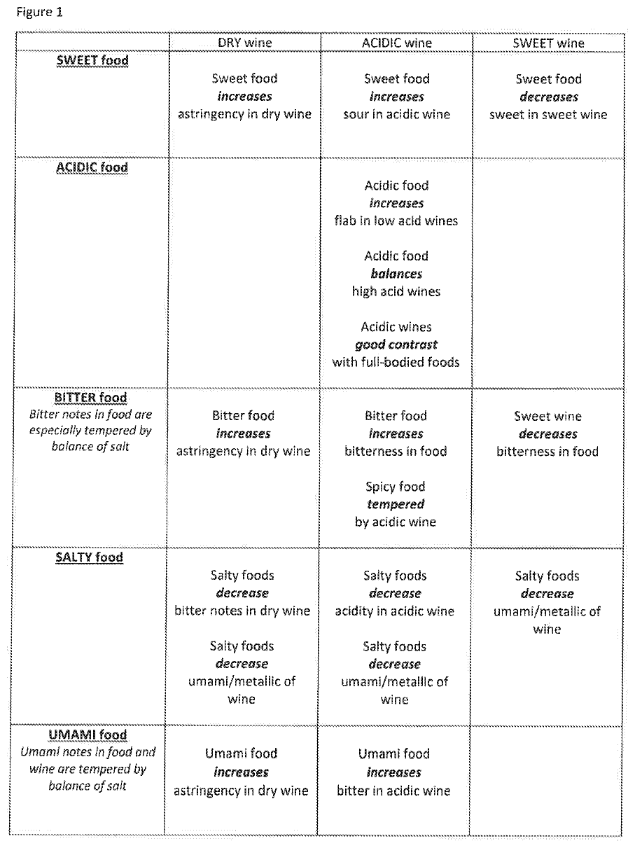

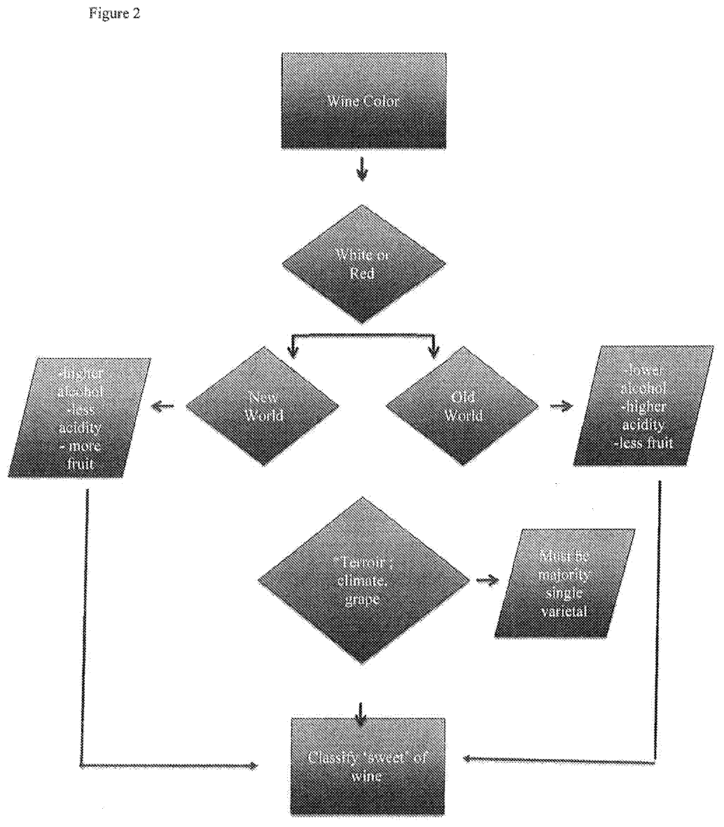

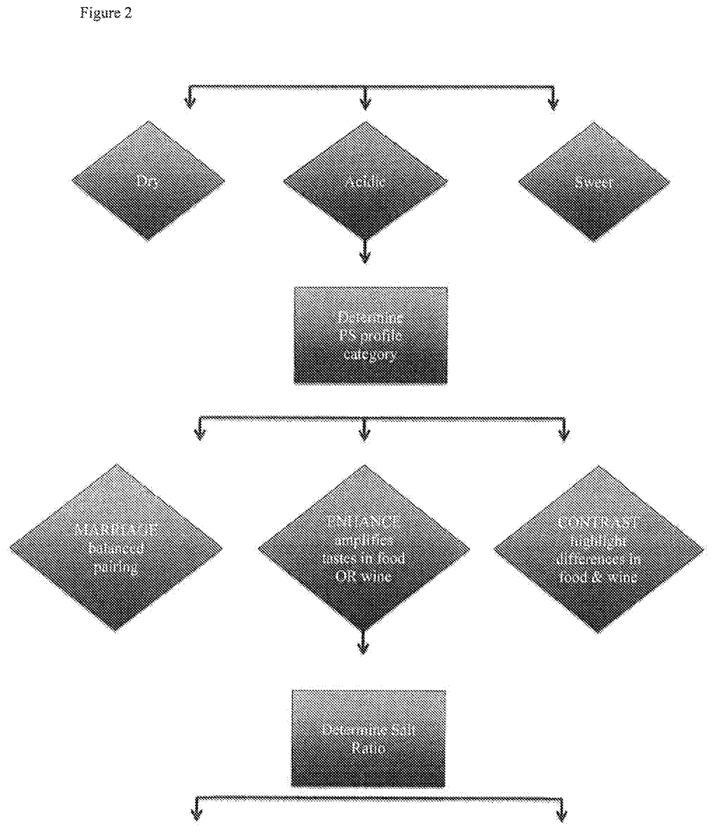

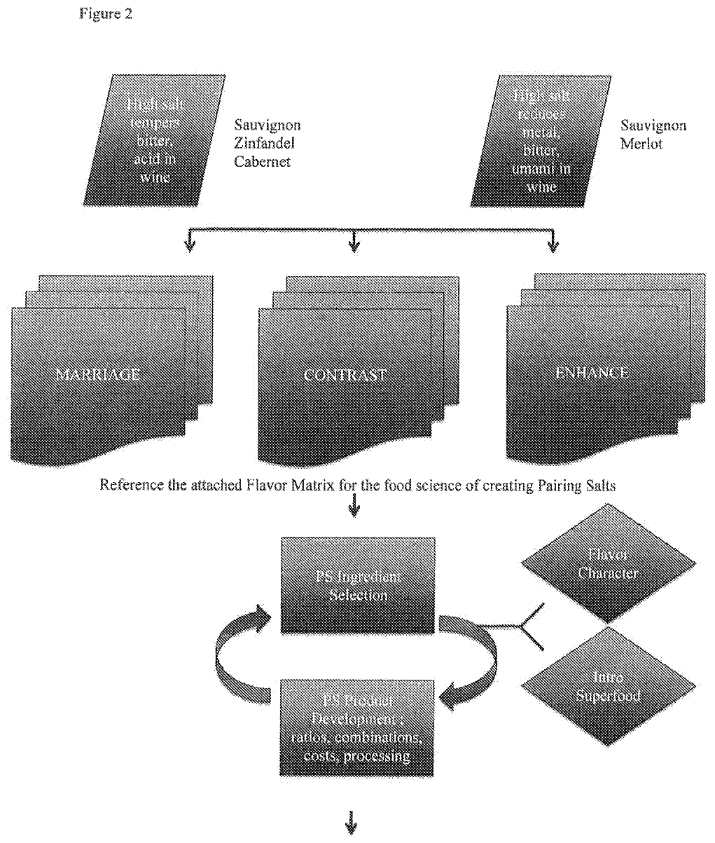

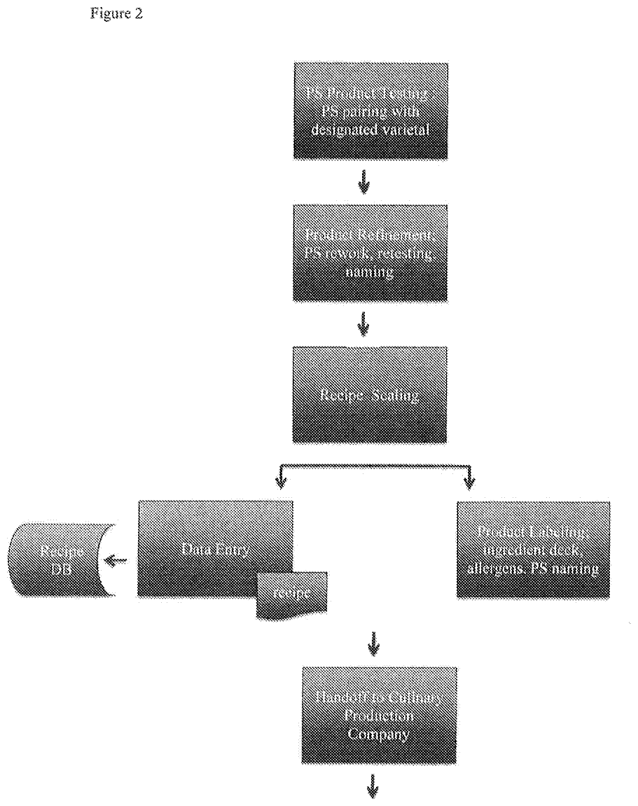

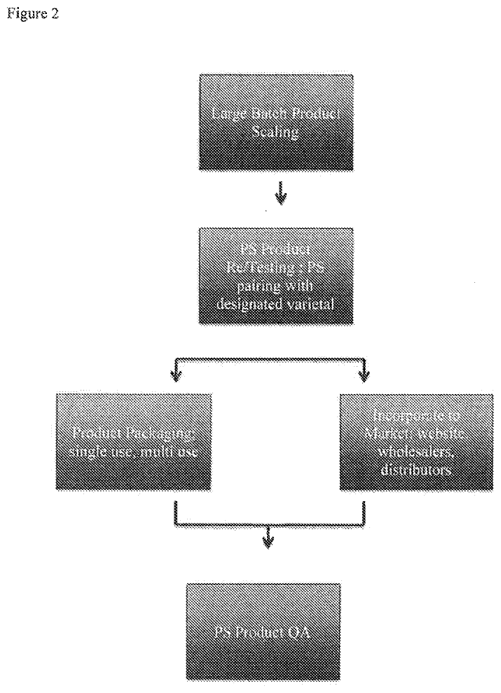

The method further includes the step of determining the varietal's Pairing Profile which is selected from one of Sweet, Dry and Acidic. Referencing FIG. 2, the Pairing Profile may be determined by considering the varietal and information related to the varietal, such as color (red, blush or white), vintner's technique in preparing the wine (e.g., New World, Old World, method champenoise/traditionelle, etc.), and the gout de terroir, derived from the terroir with which the varietal is associated.

In the practice of a method a Pairing Profile is determined and a desired gusatory objective is chosen; the composition is customized to achieve this objective when applied to a food substrate that is consumed with the grape-based beverage. The objective is selected from balance objective, a contrast objective, and an enhancement objective.

As used herein:
“balance objective” provides a gusatory experience that includes an even melding of the food and wine flavors notes; no note or flavor is more prominent than any other;
“enhancement objective” provides a gusatory experience in which few or one of the flavors or flavor notes present in the food or wine is framed by the other flavors—the selected flavor note(s) is sufficiently brought out to be identifiable but is not dominant over all other flavors present; and
“contrast objective” provides a gusatory experience in which one or more of the flavors or flavor notes present in the food or wine is clearly heightened or highlighted to be the dominant flavor experienced, while the others remain background.

Based upon the objective selected and the Pairing Profile, one or more ingredients having the flavor profiles identified in the appropriate shaded cell of Table 1 are added to the salt:

TABLE 1

| | Gusatory Objective | | |
|---|---|---|---|
| Paring Profile | Balance | Enhancement | Contrast |
| Sweet | Vanilla bean | Hibiscus | Rosemary |
| | Apricot | Lemon zest | Black Cardamom |
| Dry | Black sesame | Cocoa nibs | Clove |
| | | Cayenne | Orange oil |
| | | Caraway | Paprika |
| | | | Coriander Seed |
| Acidic | Shitake | Cumin | Mint |
| | Cane sugar | Ginger | Rosemary |
| | | Lime | |

Other ingredients may include cocoa nibs, vanilla bean, pink peppercorn, kosher salt, cayenne, clove, orange oil, hickory, paprika, apricot, lemon zest, honey, rosemary, shitake, vanilla, cumin, matcha, shallots, black cardamom, coriander seed powder, nut, walnut, ginger powder, mint, cumin, caraway, cane sugar, lime, black sesame powder, hibiscus powder. Such ingredients may be dried, dehydrated or fresh. They are preferably included in powdered or pulverized form or as finely comminuted particles, so as to mix uniformly with the salt grains.

Once the salt and the selected ingredients are combined, the customized composition is applied to a food substrate. The food substrate may be anything edible and will necessarily vary on the individual(s) consuming the food with factors such as personal and cultural preferences, availability of specific foods contributing to the variability. However, in some embodiments it may be preferred that the food substrate is a mammalian meat, red meat, a game meat, offal, a poultry meat, fish (cartilaginous and bony), a fungus, a vegetable, a tuber, a nut, a mollusk meat, a crustacean meat, an annelid meat, an echinoderm meat, a cetacean meat, a fruit, grains and legumes, an algae and food made from the same (e.g., bread). Specific examples may include, without limitation, beef, veal, pork, chicken quail, antelope, boar, ostrich, liver, sweetbreads, Portobello mushrooms, chanterelles, skirret, potatoes, skate, salmon, flounder, cod, turbot, sea bass, snails, oysters, mussels, clams, crabs, lobsters, walnuts, peanuts, sea urchin, whale, jack fruit, peaches, tomatoes, onions, earthworm, nori, spirulina, mutton, deer, goose, lentils, rice, carrots, etc.

The food treated with the customized composition is consumed by the diner(s) approximately contemporaneously with the wine or beverage of the varietal, that is, within a few seconds or minutes. Upon consumption, the diner(s) experience a taste/gusatory sensation that is different than a sensation experienced by the diner should he have co-consumed only the wine and the untreated food.

The customized composition may further include a so-called “superfood” or highly nutrient or antioxidant rich food, such as, for example, kale, pomegranate, agai, gogi, noni, seabuckthorn, mangosteen, baobob, blueberries, chia, broccoli, green tea, strawberries, salmon, almonds, ginger, turmeric, beets, cinnamon and mixtures and extracts thereof. If added, such high nutrient food(s) are preferably powdered or finely comminuted.

Also contemplated within the scope of the invention are consumables that are pre-treated with one or more of the customized compositions of the invention. For example, the customizable composition may be applied to a food which is then packaged and sold to the consumer. Pre-treated snack foods such as potato chips, lentil chips, kale chips, pretzels, crackers, snack “puffs”, popcorn, nuts, breadsticks, rice crackers, and/or dried fruits may be preferred. Alternatively, the customizable composition may be applied to a food or food that the consumer cooks at home, such as a raw beeksteak, an uncooked vegetable medley, or a salmon filet.

In addition, the customizable composition may be incorporated into a carrier that is provided to the home cook and is used by her/him to apply the customizable composition to a food. Such carriers may include an oil, water, an alcohol, and/or mixtures or emulsions of the same. Other carriers may include a butter (or imitation butter/butter substitute), a dairy carrier (such as milk, yogurt, cheese), and a dry carrier (such as cornstarch or lentil flour).

Also included are system and/or kits that permit a chef or cook to prepare a customized composition in his own kitchen, alone or in the company of friends or family (“Paring Parties”). Such system would include, for example, an quantity of salt, a quantity each of salty components, sweet components, umami components, and acidic components and a section matrix (as shown, e.g., in FIG. 1) or instructions enabling the cook/chef to practice the method of the invention. A bottle of wine of a pre-selected varietal may also be included, or may be pre-identified so the chef/cook need not undertake that step of the method himself.

“Instructions” as included in the system or kit may be provided in any media, tangible or electronic, for example, written words or cartoons on any medium, or may be in the form of video, audio, hologram, etc. The instructions may be delivered with the system/kit when it is provided to the chef/cook or may be delivered separately, e.g, streamed via the internet.

All “parts” given herein are parts by volume.

### EXAMPLES

### Example I—Customization when Varietal is Cabernet Sauvignon

The salt selected is a kosher sodium chloride salt that is iodine free. The varietal is a Cabernet Sauvignon. It was determined that the varietal had characteristics of red color, “New World” technique and a gout de terroir conferred by the cultivation environment of the United States' West Coast in a warm to moderate climate.

The customizable composition is designed for a New Word Cabernet Sauvignon. The Cabernet Sauvignon range from medium-bodied to full-bodied. This wine is characterized by higher tannins that serve to provide structure and complexity while supporting the rich dark fruit characteristics. The most common expressions found in Cabernet Sauvignon include plum, cherry warm spices, vanilla, black pepper, tobacco. Tannins play a crucial role when it comes to balancing a seasoning formula. The cabernet grape is a warm weather grape, and flavorings of this wine lend to deep and dark characteristics. Consequently, the Pairing Profile is determined to be Dry.

The objective selected is “Enhancement”. This provides latitude to explore the far-reaching nuances of Cabernet Sauvignon. West Coast United States is rich with aromatic crops, a major producer of oranges, and heavily wooded throughout the landscape.

For every 48 parts of salt, ingredients that are added to the salt are: 24 parts cocoa nibs, 6 parts ground pink peppercorn, 0.5 parts cayenne powder, 0.25 parts clove, 1 part orange oil, 1 part hickory, 0.5 parts paprika

Hickory adds elements of smoke, and barbecue which work in direct relationship with the cacao of the cocoa nibs. This helps the wine to exhibit a “chew”. Paprika and cayenne supplement the spicy properties already found in the wine. The addition of clove and its distinct anise flavor work with the pink peppercorn which is earthy. Pink peppercorn provides a subtle flavor that combines well with the vanilla and orange oil. The oil of the orange is bitter, yet floral and this wine can stand up to those properties Cabernet wines are usually high in tannins, and for this reason the ratio of salt to additional seasoning components can be greater in order to help relax the tannins. This higher ratio of salt also help to soften any acidity and astringencies that may appear in this wine. Several ingredients with this formula are attributed with superfood properties, including cocoa, cayenne, and clove. The result of this formula design is an improved overall experience where elements in both wine and food are “speaking loudly”.

### Example II—Customization when Varietal is Chardonnay

The salt selected is a kosher sodium chloride salt that is iodine free. The varietal is a Chardonnay. It was determined that the varietal had characteristics of white color, “New World” technique and a gout de terroir conferred by the cultivation environment of the United States' West Coast in a cool climate.

The customized composition is designed to pair with a Chardonnay of the new world style. This wine will offer a pronounced fruit and citrus component, higher sensation of alcohol, and low acidity. The cool climate will impress some sweetness, but more often these wines lean closer to dry on the spectrum. Accordingly, the Pairing Profile is characterized as Acidic.

A “balance” objective is selected. It is determined that the salt:additional seasoning components ratio will be lower, as this white wine will more often be drier and acidity is minimal. A balance objective implicates mirrored flavors of the region to match the terroir effect.

For every 1 part of the salt, ingredients that are added to the salt are:

2 parts dried apricot, 1 part lemon zest, 1 part honey, 1 part rosemary

Dried apricots provide a sweetness that will on its own pair well with a new world Chardonnay, but this choice in ingredient also helps to offset the astringent effect of additional citrus. Orange another major crop of this region was considered, but the sweet effects of this citrus fruit would supplement and cause a flattening of the wine. Lime causes an improvement of astringency which causes an offensive taste in the wine. Lemon is most ideal to work well with apricot, and subsequently with honey. Honey and rosemary create a space for earthy element that work to round the flavor experience. Honey is well documented to have health-aiding properties and for that reason is beneficial as a superfood addition to the formula. Rosemary being woody, and distinct in flavor and aroma, picks up on the “grassy”/“green” (herbaceous) elements in the wine. These ingredients are balanced against the salt ratio, and find a happy balance between wine and seasoning formula.

### Example III—Customization when Varietal is Syrah

The salt selected is a kosher sodium chloride salt that is iodine free. The varietal is a Syrah. It was determined that the varietal had characteristics of red color, “New World” technique and a gout de terroir conferred by the cultivation environment of the United States' West Coast in a medium climate. The pairing profile is “sweet”.

The customized composition is tailored to a New World wine style. Blackberry, plum, mocha, and peppery flavors, spice, smoke, and smooth tannins. Syrah drastically affected by growing temperature—warmer climates bring help to display mellow flavors of plum, while cooler temperatures spice up the wine, a happy medium between both is found by paying special attention to the salt to additional seasoning components ratio, and beefing up the potential of the sensation of ‘umami’.

Syrah does exhibit acidity and medium sweetness, so we can determine that ingredients for this pairing will need to be ‘meaty’, and robust. For this purpose, one selects Enhance as the objective. The salt ratio will be at the middle of the scale, so as not to thin the wine experience, and allowing for bigger flavors in the seasoning blend.

For every 2.5 parts of salt, ingredients that are added to the salt are:

3 parts shiitake mushroom (dried), 1 part vanilla bean, 1.5 parts cumin

The idea and sensation to create umami plays an important role for this design. Shiitake mushroom offer a robust flavor, and give an impression of meatiness. Cumin adds a layer of earthy pungency that when combined are reminiscent of a steak dinner. Cumin is herbaceous and aromatic, this lends to a rounded pairing experience. Vanilla bean in this formula serves to compliments the notes of mocha and berry in the wine.

### Example IV: Alternative Customization when the Varietal is Chardonnay

The salt selected is a kosher sodium chloride salt that is iodine free. The varietal is a Chardonnay. It was determined that the varietal had characteristics of white color, “Old World” and “New World” techniques and a gout de terroir conferred by the cultivation environment of Burgundy France, in a cool oceanic climate and of the United States' West Coast in a cool climate. The pairing profile is acidic.

This customization is designed for food that is paired with a Chardonnay of the new world and the old world styles. Although very similar in properties, there are very also stark difference between the two styles. The new world wine will offer a pronounced fruit and citrus component, higher sensation of alcohol, and low acidity. The cool climate will impress some sweetness, but more often these wines lean closer to dry on the spectrum. The old world style tends to offer a light body, less alcohol, and the sensation of minerality with moderate acidity.

The objective to achieve with this pairing is one of a Balance. We determine that the salt:additional seasoning components ratio will be moderate. This serves a purpose for both wines styles, where in the new world the salt with flattened the wine ever so slightly, the additional flavor components will serve to match in a way to have an effect that cause greater interest to the palette. The old world style will benefit from the salt ratio to stand up to the minerality of the wine, and again create an opportunity for the additional flavor components to match the wine improving the overall taste experience. Mirroring flavors of the region and considering the terroir of either wine style allows for the greatest opportunity for success when it comes to formula design.

For every 8 parts of salt, ingredients that are added to the salt are:

8 parts shallots (air dried), 2 parts black cardamom (ground), 2 parts coriander seed powder, 1 part ginger powder, 1 part dehydrated lime zest.

Shallots relate to Chardonnay being that onion, and onion-like (allium) flavors help to produce an effect of umami. Along with the pungency of the cardamom, coriander, and ginger act to inflate the wine, along the palette to accept sweet, salty, bitter, simultaneously. Finally, the lime zest plays off of the natural citrus notes that exist in the wine. This seasoning formula is ideally designed to play up the strongest properties of both the Old World and New World styles. In the new world wine the effect is a deeper and richer wine experience, almost “golden”. In the old world wine there is a heartier sensation that improves the ripeness of the fruit and balances the minerality of the wine.

### Example V: Alternative Customization when the Varietal is Cabernet Sauvignon

The salt selected is a kosher sodium chloride salt that is iodine free. The varietal is a Cabernet sauvignon. It was determined that the varietal had characteristics of red color, “New World” techniques and a gout de terroir conferred by the cultivation environment of the United States' West Coast in a cool climate.

Cabernet sauvignon varietals range from medium-bodied to full-bodied. This wine is characterized by higher tannins, with rich dark fruit characteristics. The objective selected for this pairing is “Balance”. The elected ingredients were carefully chosen to allow the grape in all its complexity to develop as one goes through an entire meal of food prepared with Pairing Salts. The Pairing Profile is Dry.

For every 4 parts of salt, ingredients that are added to the salt are: 6 parts black sesame powder, 1.5 parts hibiscus powder, 0.5 parts shallots (air dried), 0.5 parts dried mint.

Cabernet sauvignon wines are typically tannic, spicy, and robust. This canvas allows the development of the product to paint inside the lines. Deep and rich spices often work well with cabernet sauvignon, and for that reason one may introduce black sesame powder. Its nuttiness helps to impart properties of ‘meatiness’ to offset the drying of the tannins, and combined with the additional savory effect of the air-dried shallots.

Hibiscus powder allows this typically dry, smoky red wine to release the hidden fruit and floral notes. The dried mint, not only adds to the herbaceous and aromatic experience, but it also opens the palate to accept more of the wine flavors that would be otherwise missed.

### Example VI: Customization when the Varietal is Riesling

The salt selected is a kosher sodium chloride salt that is iodine free. The varietal is a Riesling. It was determined that the varietal had characteristics of white color, “New World” techniques and a gout de terroir conferred by the cultivation environment of the United States' West Coast in a cool climate. The pairing profile is Sweet.

Riesling grapes, which originate in Germany's Rhine region, offer up sweet fruity flavors and aromas of flowers and fruits. Other characteristics of wines made from Riesling grapes include high acidity and fresh fruit. If aged mineral, smoke and petrol sensations become more prominent. The character of a Riesling wine depends heavily on where it is grown because Riesling grapes are incredible at expressing terroir. Unlike Chardonnay, Riesling is not a wine produced with the addition of oak. The attributes of Riesling allow for the wine to be affected in a variety of ways.

The objective selected was “Enhancement”. For every 12 parts of salt, ingredients that are added to the salt are: 1 part dried mint, 1 part dehydrated lime zest, 0.5 parts cumin powder, 0.50 parts ground caraway, 0.50 parts cane sugar.

Riesling's versatility allows this wine to be an ideal wine for food matching, in that one can truly manipulate the effect and sensations. The addition of sugar to this formula helps to stabilize sweeter Rieslings, as well as help drier Rieslings to become sweeter. The effect of this can be directly compared to the sensation of “candy”, much like a hard candy. The balance of salt and sugar help to soften the wine, and the aromatic properties of the cumin powder and ground caraway create a more brilliant expression in the wine. The dehydrated lime in the classic mirroring effect help to pronounce the citrus notes. The overall effect of this formula as it relates to the wine is an invigoration of the wine. All the parts of the wine and food experience feel fuller and rounded.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-14. (canceled)

15. A consumable comprising a food substrate treated with a customized seasoning composition that modify a gustatory sensation experienced by an individual when a food substrate and an alcoholic beverage are consumed, the process comprising:
Obtaining an amount of an edible salt;
Selecting a varietal from which the alcoholic beverage is derived;
Determining the pairing profile of the alcoholic beverage selected from Sweet, Dry and Acidic;
Selecting a gustatory objective from the group consisting of a balance objective, a contrast objective, and an enhancement objective;
wherein,
when the objective is balance, and the pairing profile is Sweet, a salty component is added to the amount of salt to form a customized seasoning composition;
when the objective is balance, and the pairing profile is Dry, a component selected from a salty component and an umami component is added to the amount of salt to form a customized seasoning composition;
when the objective is balance, and the pairing profile is Acidic, a component selected from a salty component and an umami component is added to the amount of salt to form a customized seasoning composition;
when the objective is contrast, and the pairing profile is Sweet, a sweet component is added to the amount of salt to form a customized seasoning composition;
when the objective is contrast and the pairing profile is Dry, a sweet component or a bitter component is added to the amount of salt to form a to form a customized seasoning composition;
when the objective is contrast and the pairing profile is Acidic, a sweet component is added to the amount of salt to form a to form a customized seasoning composition;
when the objective is enhance, and the pairing profile is Sweet, an acidic or a sweet component is added to the amount of salt to form a to form a customized seasoning composition;
when the gustatory objective is enhance, and the pairing profile is Dry, a sweet component is added to the amount of salt to form a customized seasoning composition;
when the objective is enhance, and the pairing profile is Acidic, a component selected from acidic and sweet is added to the amount of salt to form a customized seasoning composition; and
wherein upon co-consumption by a diner of the alcoholic beverage and the consumable, a gustatory sensation experienced by the individual differs from a gustatory sensation experienced by the diner upon co-consumption of the beverage and the food substrate alone.

16. The consumable of claim 1, wherein the food substrate is selected from a hand-held snack food.

17. The consumable of claim 1, wherein the food substrate is selected from the group consisting of potato chips, lentil chips, kale chips, pretzels, crackers, snack “puffs”, popcorn, nuts, breadsticks, rice crackers, and dried fruit.

18. The consumable of claim 1 wherein the beverage is selected from the group consisting of wine, beer, spirit, liquor and an aperitif.

19. The consumable of claim 1 wherein the beverage is selected from the group consisting of absinthe, brandy, sake, whiskey, tequila, scotch, rum, beer, lager or stout, vermouth, vodka, gin, bourbon, port and rye.

20. The consumable of claim 1 wherein the food substrate is treated with a customized seasoning composition prior to sale.

21. The consumable of claim 1 wherein the edible salt is sodium chloride.

22. The consumable of claim 1 wherein the sweet component is selected from black sesame powder, vanilla bean, apricot, and cane sugar.

23. The consumable of claim 1 wherein the salty component is selected from cayenne, caraway, cumin, hibiscus, coriander and paprika.

24. The consumable of claim 1 wherein the acidic component is selected from lime zest, lemon zest, orange oil and ginger.

25. The consumable of claim 1 wherein the bitter component is selected from paprika and cocoa nibs, the umami component is selected from shitake mushroom, soy sauce and rosemary.

26. The consumable of claim 25 wherein the customized food seasoning is applied to the food substrate by incorporating it into a carrier and the resulting carrier compostion is applied to the food substrate.

27. The consumable of claim 25 wherein the carrier is selected from the group consisting of an oil, water, an alcohol, and mixtures or emulsions of thereof.

28. The consumable of claim 25 wherein the carrier is selected from the group consisting of a butter, an imitation butter, a dairy carrier, milk, yogurt, cheese, a dry carrier, cornstarch, and flours.
